(19) United States
(12) Patent Application Publication
(10) Pub. No.: US 2015/0274066 A1
(43) Pub. Date: Oct. 1, 2015

(54) VEHICLE TRIM PANELS WITH INTERIOR ILLUMINATION SYSTEMS

(71) Applicant: GM GLOBAL TECHNOLOGY OPERATIONS LLC, Detroit, MI (US)

(72) Inventors: LUIS MIGUEL DEL POZO GONZALEZ, PUEBLA (MX); CRISTIAN MANUEL SANCHEZ PORTILLO, TOLUCA (MX); CARMEN CONSUELO RODRIGUEZ LEON, NAUCALPAN DE JUAREZ (MX)

(73) Assignee: GM GLOBAL TECHNOLOGY OPERATIONS LLC, Detroit, MI (US)

(21) Appl. No.: 14/229,276

(22) Filed: Mar. 28, 2014

(51) Int. Cl. B60Q 3/00; B60Q 3/02

(52) U.S. Cl. CPC B60Q 3/004; B60Q 3/0243

(57) ABSTRACT

An illumination system for an interior of a vehicle is provided. The system includes a translucent substrate and a light pipe positioned proximate to the translucent substrate such that light emitted from the light pipe passes through the translucent substrate into the interior of the vehicle.

### TECHNICAL FIELD

The technical field generally relates to illumination systems, and more particularly relates to vehicle trim panels with interior illumination systems.

### BACKGROUND

Motor vehicles typically include trim panels that cover portions of the interior structure, such as the instrument panel and the door panels. In some vehicles, interior illumination systems are incorporated into these panels in order to provide ambient lighting within the vehicle passenger compartment. However, it remains a challenge to provide an illumination system that is attractive, distinctive, even, and suitable for a vehicle.

Accordingly, it is desirable to provide improved vehicle trim panels with interior illumination systems. Furthermore, other desirable features and characteristics of the present invention will become apparent from the subsequent detailed description and the appended claims, taken in conjunction with the accompanying drawings and the foregoing technical field and background.

### SUMMARY

An illumination system for an interior of a vehicle is provided. The system includes a translucent substrate and a light pipe positioned proximate to the translucent substrate such that light emitted from the light pipe passes through the translucent substrate into the interior of the vehicle.

A trim panel of a vehicle with an interior and an exterior is provided. The trim panel includes a first wall defining a first window facing the interior of the vehicle and a second wall coupled to the first wall to define a cavity. The trim panel further includes an illumination system with a translucent substrate coupled to the first wall at the first window and a light pipe positioned proximate to the translucent substrate such that light emitted from the light pipe passes through the translucent substrate and through the window of the first wall into the interior of the vehicle

### DESCRIPTION OF THE DRAWINGS

The exemplary embodiments will hereinafter be described in conjunction with the following drawing figures, wherein like numerals denote like elements, and wherein:

FIG. 1 is a schematic view of a vehicle interior illumination system incorporated into a trim panel in accordance with an exemplary embodiment;

FIG. 2 is a cross-sectional view of the vehicle interior illumination system of FIG. 1 in accordance with an exemplary embodiment;

FIG. 3 is a front side view of the vehicle interior illumination system of FIG. 1 in accordance with an exemplary embodiment;

FIG. 4 is a partial, back side view of the vehicle interior illumination system of FIG. 1 in accordance with an exemplary embodiment;

FIGS. 5-10 are partial, cross-sectional views of vehicle interior illumination systems in accordance with additional exemplary embodiments;

FIG. 11 is a front side view of the vehicle interior illumination system of FIG. 1 in accordance with an another exemplary embodiment; and

FIG. 12 is a partial, back side view of the vehicle interior illumination system of FIG. 1 in accordance with another exemplary embodiment.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description.

The following description refers to elements or features being “connected” or “coupled” together. As used herein, “connected” may refer to one element/feature being directly joined to (or directly communicating with) another element/feature, and not necessarily mechanically. Likewise, “coupled” may refer to one element/feature being directly or indirectly joined to (or directly or indirectly communicating with) another element/feature, and not necessarily mechanically. However, it should be understood that although two elements may be described below, in one embodiment, as being “connected,” in alternative embodiments similar elements may be “coupled,” and vice versa. Thus, although the schematic diagrams shown herein depict example arrangements of elements, additional intervening elements, devices, features, or components may be present in an actual embodiment.

Broadly, exemplary embodiments discussed herein provide improved illumination systems that may be incorporated into trim panels in the passenger compartment of the vehicle. The vehicle interior illumination systems include a flexible light pipe mounted on a translucent substrate, such as, but not limited to, acrylonitrile butadiene styrene (ABS). In this manner, the flexible light pipe provides direct lighting to the substrate. The translucent substrate functions to evenly distribute the light as necessary or desired, including in predetermined decorative patterns, and provides advantageous mechanical and/or structural support within the passenger compartment. Some embodiments may include a cover for securing the light pipe to the substrate and/or for directing light from the light pipe to the substrate.

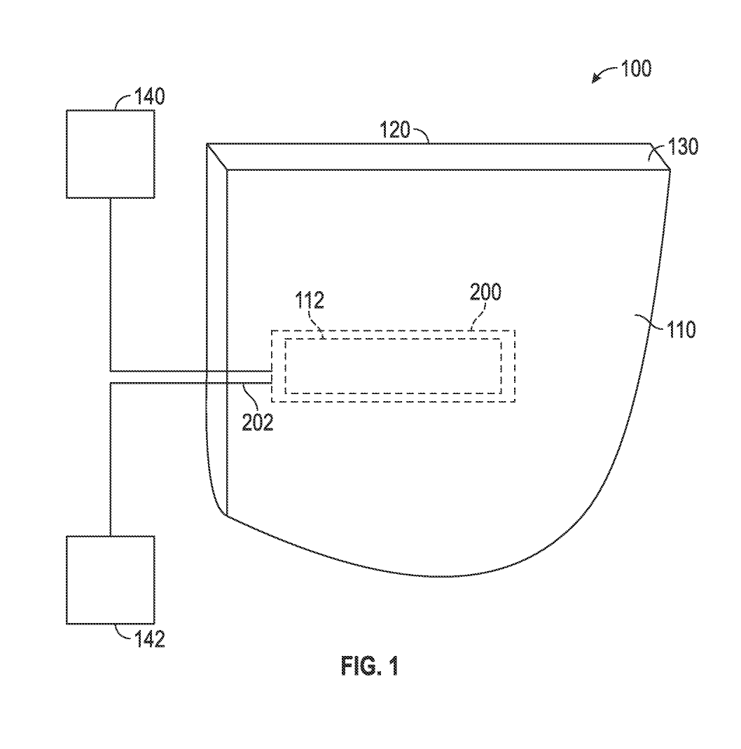

FIG. 1 is a schematic view of a vehicle interior illumination system 200 incorporated into a trim panel 100 in accordance with an exemplary embodiment. In general, the trim panel 100 is configured to be incorporated into the body of a vehicle, such as a vehicle door, seat, or arm rest. In various other embodiments, the trim panel 100 may be incorporated into a floor center console, A/B/C pillar garnishes, or instrument panel.

In the depicted exemplary embodiment, the trim panel 100 is suitable to be incorporated into a door and includes a first (or interior) wall 110 and a second (or exterior) wall 120 that define an internal cavity (or space) 130. In one exemplary embodiment, the first wall 110 is positioned on the interior of the vehicle, e.g., within the passenger compartment. The second wall 120 may be exposed as the exterior surface of the vehicle or face other, more exterior structures or components of the vehicle.

In general, the illumination system 200 is positioned within the internal cavity 130 between the first and second walls 110, 120 such that the illumination system 200 produces an ambient light within the passenger compartment of the vehicle. The illumination system 200 may be arranged within a window or hole 112 within the first wall 110 to emit light directly into the passenger compartment, or the illumination system 200 may emit light through the first wall 110.

As also shown in FIG. 1, the illumination system 200 may include a wire harness 202 that couples the illumination system 200 to a power source (e.g., a vehicle battery) 140 and a control module 142 (e.g., an electronic control unit). In general, the power source 140 is configured to provide electrical energy to a light source of the illumination system 200, and the control module 142 is configured to control operation of the light source of the illumination system 200. As examples, the control module 142 may activate the illumination system 200 (e.g., “off” or “on”), as well as controlling intensity, timing, and/or pattern of illumination. As such, the control module 142 may include any suitable processing and storage units, integrated circuits, or the like. The control module 142 may be, for example, a vehicle electronic control unit (ECU).

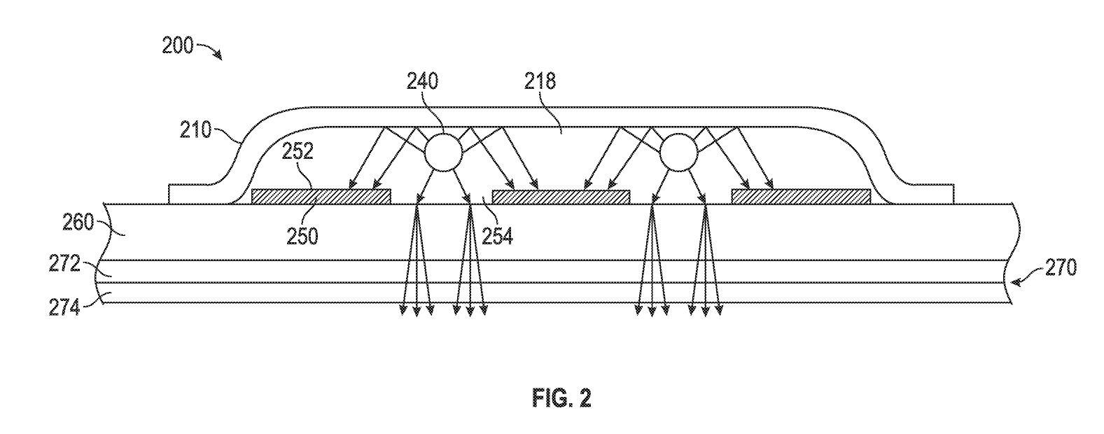

FIG. 2 is a cross-sectional view of the vehicle interior illumination system 200 of FIG. 1 in accordance with an exemplary embodiment. The illumination system 200 includes a carrier 210, a light pipe (or source) 240, a pattern layer 250, a substrate 260, and a front cover 270. Additional reference is made to FIGS. 3 and 4. FIG. 3 is a front side view of the illumination system 200, and FIG. 4 is a back side view of the illumination system 200 of FIG. 1 with the carrier 210 removed. Each component will be introduced prior to a more detailed description of operation.

Generally, the carrier (or rear cover) 210 is arranged facing the internal space 130 of the trim panel 100 (FIG. 1). In some embodiments, the carrier 210 may be referred to as the “B-side” of the illumination system 200. As shown, the carrier 210 defines a cavity 218 with the substrate 260. In general, the carrier 210 functions as a housing for the illumination system 200 and to recover light from the light pipe 240 by reflecting such light towards the substrate 260. Additionally, the opacity of the carrier 210 may facilitate light blockage to prevent leakage from areas not intended for illumination. As such, the carrier 210 may generally be sized and shaped to extend over the area to be illuminated and house the light pipe 240. The carrier 210 may be a white or reflective substrate, such as cardboard or any other suitable structure. As an example, the carrier 210 may be a white opaque carrier made of LG Chem ABS XR401.

As also shown in FIG. 2, the carrier 210 may be used to mount the illumination system 200 in the trim panel 100. As shown, the carrier 210 may extend laterally beyond the other components (e.g., the light pipe 240, pattern layer 250, and substrate 260) and secure the illumination system 200 to the first wall 110. Such securement may include permanent attachments such as plastic welding (e.g., heat staking welds, ultrasonic welding, and the like) or detachable attachments such as screws or snap-on fasteners. The overlapping portion of the carrier 210 may be, for example, 15 mm 25 mm and additionally function to seal the illumination system 200 from light leakage. Additional arrangements of attachment and installation are discussed below.

As noted above, the light pipe 240 is positioned within the cavity 218 formed by the carrier 210 and substrate 260. In one exemplary embodiment, the light pipe 240 may be an extruded, flexible light guide that emits light in a 360° radial pattern. The light pipe 240 may include, as examples, any suitable arrangement of LEDs and operating electronics within or proximate to an elongated housing or carrier. Reference is briefly made to FIG. 4, which depicts the light pipe 240 in a serpentine arrangement. The light pipe 240 may be a commercially available light pipe, such as E-LAN™ extruded flexible pipe. Such light pipe 240 may have a diameter, for example, of 3 mm-5 mm. As another example, the light pipe 240 may be a fiber optics light pipe with a diameter, for example, of 2.2 mm. Other types light pipes may be provided. In the depicted embodiment, light pipe 240 has two legs 242, 244 extending from a bend 246. In other embodiments, the light pipe 240 may have additional bends and legs (e.g., in an S-pattern) and/or form only a single extended leg. In one exemplary embodiment, the legs 242, 244 may be separated from one another by a distance 248 of 20 mm-25 mm with a 20 mm-bend radius, as examples. In other embodiments, the legs 242, 244 may be separated from one another by a distance 248 of 10 mm-15 mm, depending on the type of light pipe 240 and the size. Although not shown, additional light pipes may be incorporated into the illumination system 200.

The illumination system 200 further includes a pattern layer (or mask) 250. In general, the pattern layer 250 includes opaque portions 252 and one or more pattern portions 254. The opaque portions 252 are configured to block light, while the pattern portions 254 are configured to transmit light such that a decorative or functional pattern is visible during operation. The pattern portion 254 may be formed by perforations in the opaque portions 252 or a transmissive or clear material incorporated into a window or void within the opaque portions 252. In the depicted embodiment, the pattern layer 250 is positioned between the light pipe 240 and the substrate 260. In other embodiments, the pattern layer 250 is positioned on the opposite side of the substrate 260. Additionally, as discussed below, the pattern layer 250 may be omitted in some embodiments.

The substrate 260 is positioned to cover or at least partially cover the cavity 218 and extend over the light pipe 240. As noted above, the pattern layer 250 may be affixed to the substrate 260 between the substrate 260 and the light pipe 240.

The substrate 260 may be formed by one or more extruded or injection molded components. The substrate 260 performs a number of functions. In one exemplary embodiment, the substrate 260 provides structural support for the illumination system 200 in the form of sufficient rigidity, hardness, and stiffness to comply with guidelines or requirements associated with the trim panel 100 (FIG. 1). In particular, the substrate 260 may have mechanical and structural properties sufficient to be acceptable for use in the interior of a vehicle. For example, a trim panel 100 incorporated into a vehicle door is typically designed with minimum side impact requirements, and a trim panel 100 incorporated into arm rest trim is typically designed with minimum vertical stiffness requirements. The structural properties of the substrate 260 facilitate compliance with these requirements. In addition, the substrate 260 may particularly provide a relatively stiff structure to impart an acceptable “perceived quality” to the customer, as well as satisfactory mechanical deformation requirements due to specific static or dynamic loads, including noise and vibration performance requirements.

Additionally, the substrate 260 has advantageous optical characteristics for the illumination system 200, as will be described in greater detail below. In one exemplary embodiment, the substrate 260 is a thermoplastic such as acrylonitrile butadiene styrene (ABS), particularly a natural ABS. As examples, the substrate 260 may be ABS resins, such as INEOS™ Lustran Elite HH ABS 1827 and/or STYRON™ Magnum 3325 MT. In further embodiments, the substrate 260 may be a polycarbonate/acrylonitrile butadiene styrene (PC-ABS).

As noted above, the substrate 260 may be formed from ABS, which is an amorphous thermoplastic with random molecular structure. In ABS, the characteristic size of the largest ordered region is on the order of a carbon-carbon bond, and this dimension is much smaller than the wavelength of visible light, thereby providing the diffusive and translucent characteristics of natural ABS. As such, in one exemplary embodiment, the substrate 260 is natural ABS that does not use color pigments or additives. As such, the “natural” or “milky” appearance of ABS, functions to diffuse the appropriate amount of light to provide even illumination. Additional details about the resulting operation of the illumination system 200 are provided below.

In some embodiments, the substrate 260 may have regions formed by natural ABS, as described above, and regions with opaque ABS formed by color pigments, such as black. Such a multi-region substrate may be formed by two-shot injection molding. In some embodiments with a multi-region substrate, the pattern layer 250 may be omitted and the decorative or functional pattern may be formed by the contrast in the light transmissive, natural ABS region and the opaque ABS region.

The cover 270 is arranged over the substrate 260. In general, the cover 270 may be coplanar with the first wall 110 of the trim panel 100 (FIG. 1) such that the illumination system 200 aesthetically blends into the vehicle interior. Typically, the cover 270 is a transmissive or partially transmissive material that allows light to pass. As shown, the cover 270 may include one or more layers, including an insulation or padding layer 272 and a fabric layer 274. The padding layer 272 may be, for example, open cell foam, felts, or the like, while the fabric layer 274 may be fabric material or vinyl skin. As one example, the padding layer 272 may be a polyester mesh with a thickness of about 1 mm-5 mm. In some embodiments, the fabric layer 274 may be perforated with small openings on the order of less than 1 mm to increase light transmission, if necessary or desired. Additionally, the thread count and color of the fabric layer 274 may be selected based on light transmission properties. In some embodiments, the pattern layer 250 and the cover 270 may be an integrated layer. In some embodiments, the cover 270, particularly the padding layer 272, may additionally function to diffuse light from the light pipe 240 and the substrate 260.

Reference is briefly made to FIG. 3, which is a front view of the illumination system 200. In FIG. 3, the pattern 300 is visible from the front side of the illumination system. As noted above, the illuminated pattern 300 formed by the light emitted through the pattern portions 254 of the pattern layer 250. As such, during operation, the illumination system 200 is configured to illuminate the pattern 300 with a predetermined brightness and in an even manner. The pattern 300 may also be referred to as the “shine-through area,” indicating the intended area of illumination. The pattern 300 may have any suitable form or shape by modifying, for example, the pattern portions 254 of the pattern layer 250. In some embodiments, the pattern layer 250 may be omitted and the pattern (e.g., pattern 300) may be formed by characteristics of the light pipe 240, the carrier 210, and the substrate 260, as will be discussed below. Although the pattern 300 is depicted with a distinct border or outline, in some embodiments, the pattern 300 may be designed with gradients of light transmission such that the illuminated pattern “fades” into the opaque portions.

As such, during operation, the illumination system 200 functions to illuminate a predetermined pattern or region with a direct backlight configuration. Referring again to FIG. 2, a portion of the light (indicated by arrows) from the light pipe 240 passes directly from the light pipe 240 through the substrate 260, the pattern layer 250, and the cover 270. The portion of light entering the substrate 260 undergoes scattering and diffusion to more evenly spread the light emitted from the illumination system 200. In particular, the substrate 260 is selected for the appropriate optical properties. As noted above, the substrate 260 may be formed from natural ABS to diffuse the appropriate amount of light to provide even illumination. As noted above, any portion of light striking the carrier 210 is reflected back into the cavity 218, towards the substrate 260.

The arrangement of the illumination system 200 may be considered a direct light arrangement in that the light pipe 240 emits the light in an area proximate to the area to be illuminated. Since the light pipe 240 may be located proximate to the desired area and the light is evenly distributed, substantial weight, complexity, and performance advantages may be realized.

The air gaps or spacing between the light pipe 240 and the substrate 260 and between the light pipe 240 and the substrate 260 may also impact the optical characteristics. As examples and referring to FIG. 2, the distance between the light pipe 240 and the substrate 260 and the distance between the light pipe 240 and the carrier 210 may be 1.5 mm-3 mm.

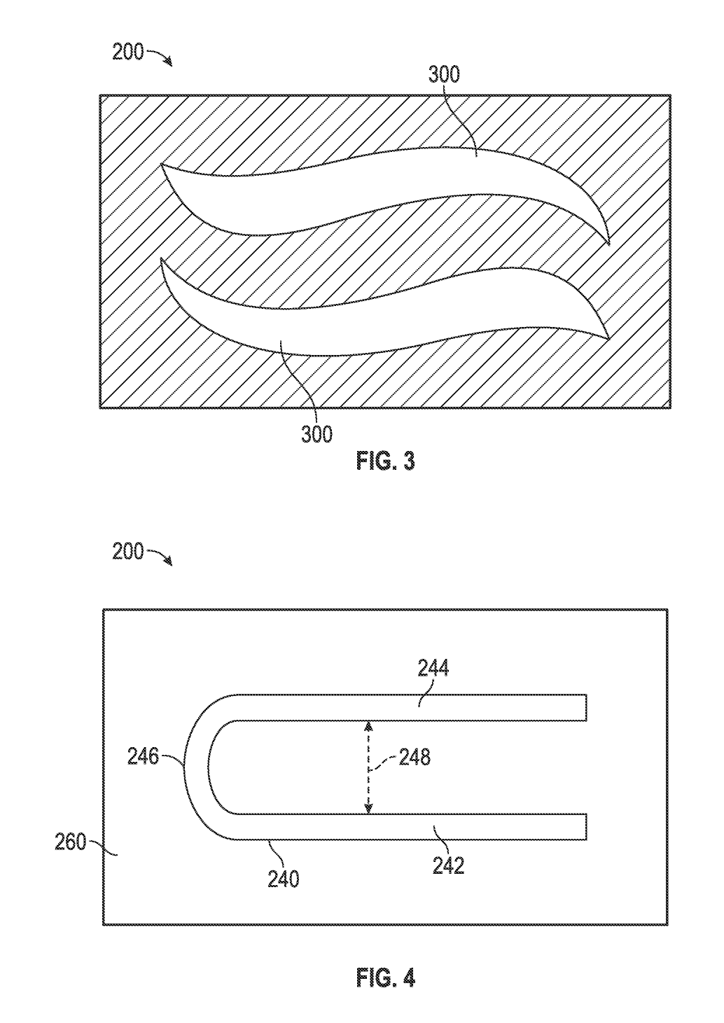

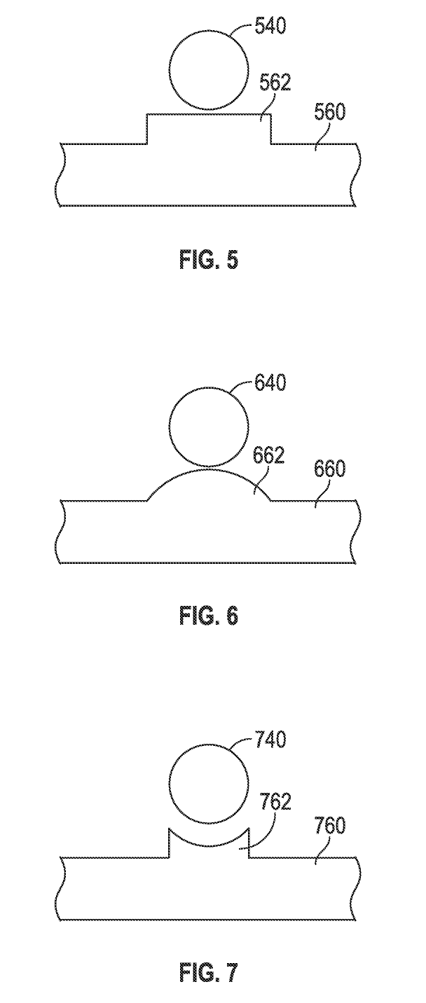

Other exemplary embodiments of illumination systems are depicted in FIGS. 5-10, which are partial cross-sectional views of other arrangements. Unless otherwise noted, the exemplary embodiments discussed below have structures and functions similar to the vehicle illumination system discussed above. In particular, FIGS. 5-7 depict embodiments having a substrate with thickened portions to provide more even light distribution by reducing or mitigating potential uneven bright or hot spots resulting from the direct lighting arrangement of the light pipe and the substrate. For example, FIG. 5 depicts a substrate 560 with a thickened portion 562 adjacent to the light pipe 540. In this exemplary embodiment, the thickened portion 562 is generally flat and may have a thickness, for example, of about 2.5 mm. FIG. 6 depicts a substrate 660 with a thickened portion 662 adjacent to the light pipe 640. In this exemplary embodiment, the thickened portion 662 is generally concave and may have a thickness, for example, of about 2.5 mm. FIG. 7 depicts a substrate 760 with a thickened portion 762 adjacent to the light pipe 740. In this exemplary embodiment, the thickened portion 762 is generally convex and may have an overall thickness, for example, of about 2.5 mm and a depression thickness, for example, of about 0.5 mm. The thickened portions 562, 662, 762 of FIGS. 5-7 may have widths approximately equal to the corresponding light pipes 540, 640, 740.

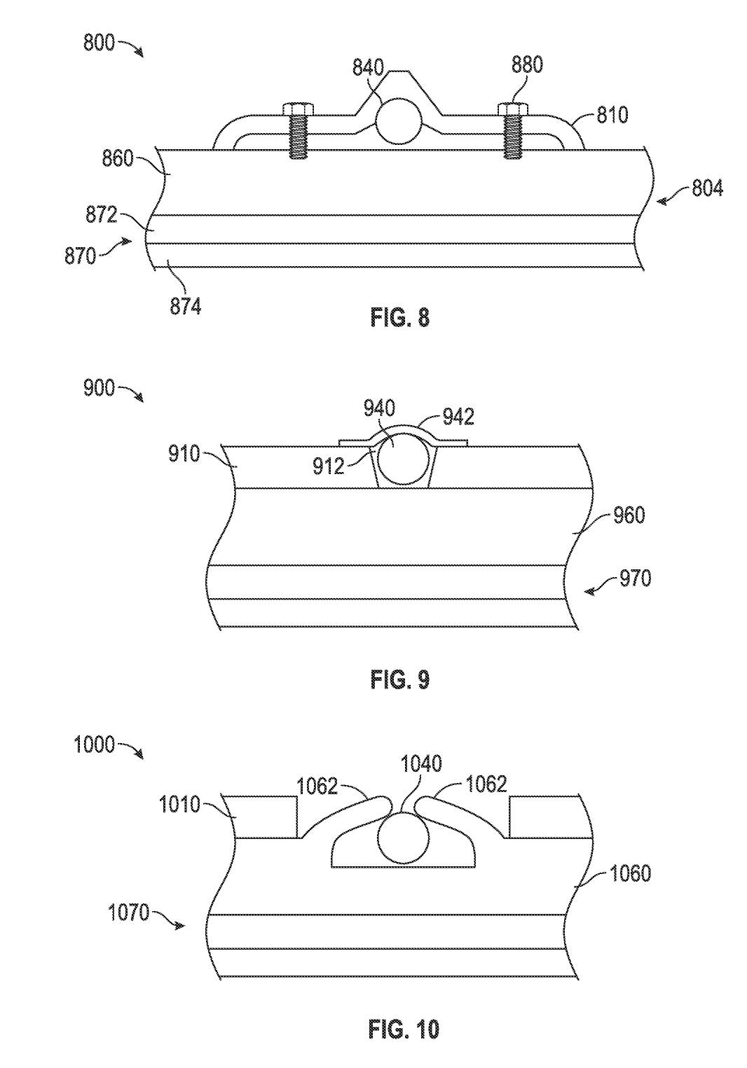

FIG. 8 is a partial, cross-sectional view depicting a vehicle interior illumination system 800 in accordance with a further exemplary embodiment. In the depicted embodiment, the vehicle illumination system 800 includes a carrier 810, a light pipe 840, and substrate 860 within a trim panel 804. The vehicle illumination system 800 further includes a cover portion 870, which may include a padding layer 872 and a cover 874. As noted above, the cover portion 870 may be integrated with the vehicle illumination system 800 and/or may be consider part of the trim panel 804.

In this exemplary embodiment, the carrier 810 is in close proximity to the light pipe 840. In particular, the carrier 810 may be molded or shaped into the arrangement and shape of the light pipe 840. In this exemplary embodiment, a pattern layer (e.g., pattern layer 250 of FIG. 2) may be omitted as a result of light having a more limited distribution in the smaller gap or cavity before entering the substrate 860.

FIG. 8 additionally depicts the mounting and installation features. In particular, the carrier 810 may be attached to the substrate 860 with screws (or clips) 880. This arrangement also fixes and mechanically retains the light pipe 840 by capturing the light pipe 840 between the carrier 810 and the substrate 860. In other embodiments, the light pipe 840 may be mechanically retained relative to the substrate 860 with clamps, adhesive, or any suitable attachments.

FIG. 9 is a partial cross-sectional view depicting another arrangement of a vehicle interior illumination system 900 in accordance with a further exemplary embodiment. In the depicted embodiment, the vehicle illumination system 900 includes a carrier 910, a light pipe 940, substrate 960, and cover portion 970.

FIG. 9 particularly depicts a portion of the illumination system 900 that enables access to the light pipe 940 and may be implemented into any of the embodiments discussed above. In this exemplary embodiment, the carrier 910 does not enclose the light pipe 940. Instead, the carrier 910 extends on either side of the light pipe 940, and the light pipe 940 may be covered by a temporary or semi-permanent cover, such as tape 942. The tape 942 may prevent light leakage from the cavity 912. The carrier 910 may have a V-shaped opening or cavity 912 to prevent displacement of the light pipe 940. The exemplary embodiment of FIG. 9 may be used in conjunction with the other embodiments described above along a portion of the illumination system 900 to provide access to the light pipe 940. In particular, wires (e.g., harness 202 of FIG. 1) and/or other accessories may be coupled to the light pipe 940 in the arrangement depicted in FIG. 9 without interference from the carrier 910, thereby enabling simple installation and maintenance.

FIG. 10 is a partial cross-sectional view depicting another arrangement of a vehicle interior illumination system 1000 in accordance with a further exemplary embodiment. In the depicted embodiment, the vehicle illumination system 1000 includes a carrier 1010, a light pipe 1040, substrate 1060, and cover portion 1070.

The embodiment of FIG. 10 is similar to the embodiment of FIG. 9 in depicting a portion of the illumination system 1000 that enables access to the light pipe 1040. In this exemplary embodiment, the carrier 1010 does not enclose the light pipe 1040. Instead, the carrier 1010 extends on either side of the light pipe 1040, and the light pipe 1040 may be partially covered by protrusions 1062 extending from the substrate 1060, thereby providing improved access for installation and coupling of wires and/or other accessories.

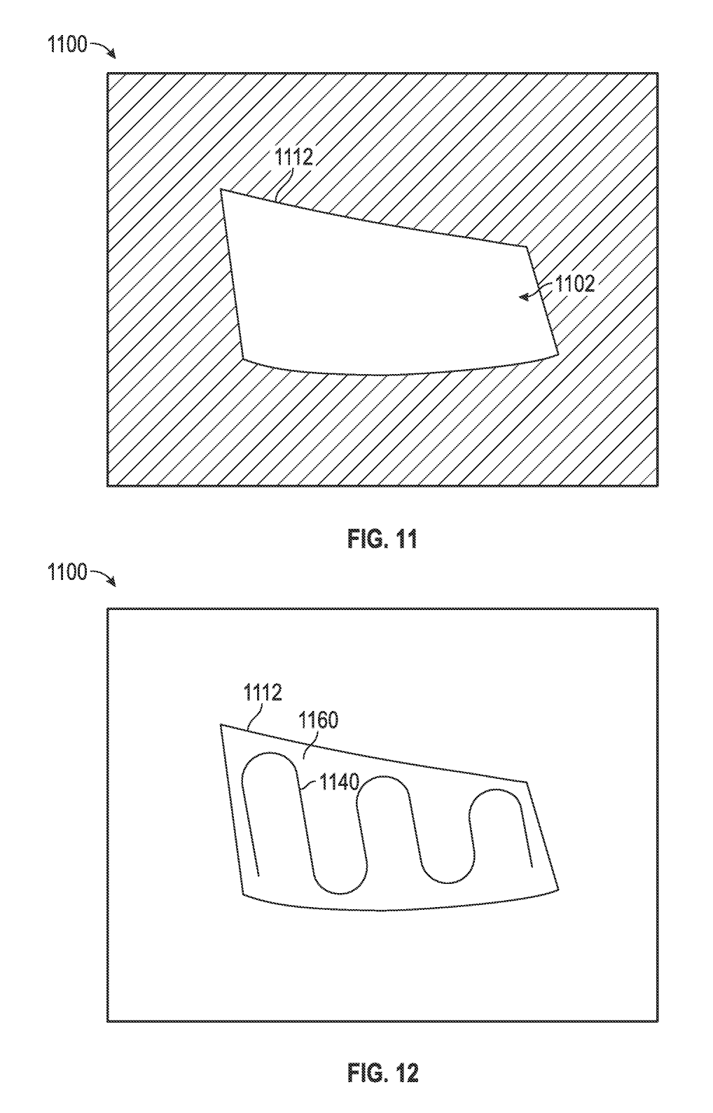

As noted above, the illumination system 200 described above may be used to form any type of illuminated pattern. As another example, FIGS. 11 and 12 are a front side view and a back side view with the carrier removed, respectively, of a vehicle interior illumination system 1100 in accordance with an another exemplary embodiment. Unless otherwise noted, the illumination system 1100 may have similar features to that of the illumination system 200 discussed above. In this exemplary embodiment, the illuminated pattern 1102 is a “full area” illuminated pattern in which an entire region is evenly illuminated. As above, the pattern 1102 may be formed by a combination of light pipe, substrate, pattern layer, cover, and carrier. In particular, in the example shown by FIG. 11, the pattern 1102 may be formed by a light pipe 1140 directing light through a translucent substrate 1160. In FIG. 11, the position of the carrier is generally indicated by line 1112. In one exemplary embodiment, the outer dimensions of pattern 1102 may be defined by the carrier 1112, as shown, and/or an opaque pattern layer.

Accordingly, improved vehicle interior illumination systems have been described that provide a relatively low cost, reduced complexity passenger compartment illumination solution, particularly as compared to conventional illumination systems. In one exemplary embodiment, the even distribution of light is a result of the material of the substrate, such as ABS, as well as the arrangement of the substrate relative to the light pipe and carrier. Typically, conventional illumination systems require additional components, tooling, and cost, particularly in the form of additional lenses and optical features of various materials and characteristics to adequately diffuse the light. For example, exemplary embodiments of the illumination system described may additional obviate the use of molded light guides that are typically custom engineered as clear plate designs to transport light from a light pipe on the side, at a distance from the area of the illumination, with complex extraction features that attempt to compensate for light dimming along the length. Molded light guides of conventional systems require investment in custom injection molding tools and additional weight. In contrast, exemplary embodiments discussed above enable placement of a light source in the form of a light pipe in any desired location and/or orientation within the passenger compartment. Such extruded light pipes have the advantage of avoiding production tooling engineering development, build, and resulting financial investment.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. An illumination system for an interior of a vehicle, comprising:
a translucent substrate; and
a light pipe positioned proximate to the translucent substrate such that light emitted from the light pipe passes through the translucent substrate into the interior of the vehicle.

2. The illumination system of claim 1, wherein the translucent substrate is a thermoplastic material.

3. The illumination system of claim 1, wherein the translucent substrate is an acrylonitrile butadiene styrene (ABS) material.

4. The illumination system of claim 1, further comprising a carrier securing the light pipe to the translucent substrate.

5. The illumination system of claim 4, wherein the light pipe is arranged between the translucent substrate and the carrier such that the carrier reflects at least a portion of the light from the light pipe towards the translucent substrate.

6. The illumination system of claim 1, further comprising a pattern layer arranged between the light pipe and the translucent substrate and defining a predetermined pattern of illumination.

7. The illumination system of claim 1, wherein the carrier defines a window proximate to a portion of the light pipe.

8. The illumination system of claim 1, wherein the translucent substrate includes a thickened portion proximate to at least a portion of the light pipe.

9. The illumination system of claim 8, wherein the thickened portion has a first width and a light pipe has a second width, the first width being approximately equal to the second width.

10. The illumination system of claim 8, wherein the thickened portion is concave or convex.

11. A trim panel of a vehicle with an interior and an exterior, comprising:
a first wall defining a first window facing the interior of the vehicle;
a second wall coupled to the first wall to define a cavity; and
an illumination system comprising:
a translucent substrate coupled to the first wall at the first window; and
a light pipe positioned proximate to the translucent substrate such that light emitted from the light pipe passes through the translucent substrate and through the window of the first wall into the interior of the vehicle.

12. The trim panel of claim 11, wherein the translucent substrate is a thermoplastic material.

13. The trim panel of claim 11, wherein the translucent substrate is an acrylonitrile butadiene styrene (ABS) material.

14. The trim panel of claim 11, further comprising a carrier securing the light pipe to the translucent substrate.

15. The trim panel of claim 14, wherein the carrier has portions overlapping the translucent substrate that secure the illumination system to the first wall.

16. The trim panel of claim 14, wherein the light pipe is arranged between the translucent substrate and the carrier such that the carrier reflects at least a portion of the light from the light pipe towards the translucent substrate.

17. The trim panel of claim 11, wherein the carrier defines a window proximate to a portion of the light pipe.

18. The trim panel of claim 11, wherein the translucent substrate includes a thickened portion proximate to at least a portion of the light pipe.

19. The trim panel of claim 18, wherein the thickened portion has a first width and a light pipe has a second width, the first width being approximately equal to the second width.

20. A trim panel of a vehicle with an interior and an exterior, comprising:
a first wall defining a first window facing the interior of the vehicle;
a second wall coupled to the first wall to define a cavity; and
an illumination system comprising:
a translucent substrate coupled to the first wall at the first window, the translucent substrate being a natural acrylonitrile butadiene styrene (ABS) material;
a light pipe positioned proximate to the translucent substrate such that light emitted from the light pipe passes through the translucent substrate and through the window of the first wall into the interior of the vehicle; and
a carrier defining a cavity with the translucent to house the light pipe, the carrier having portions overlapping the translucent substrate that secure the illumination system to the first wall, the carrier defining a window proximate to a portion of the light pipe.
